(19) United States
(12) Patent Application Publication
(10) Pub. No.: US 2007/0264019 A1
(43) Pub. Date: Nov. 15, 2007

(54) Remote controller with narrowed acting angle

(76) Inventors: Keng-Hao Nien, Taichung City (TW); Horng-Tsann Huang, Hsinchu City (TW); Chia-Liang Liu, Sinfong Township (TW); Ching-Hwa Lin, Hsinchu City (TW); Shih-Hsien Huang, Hsinchu City (TW); Shih-Jung Yeh, Sinwu Township (TW)

Correspondence Address: RABIN & Berdo, PC, 1101 14TH STREET, NW, SUITE 500, WASHINGTON, DC, 20005, US

(21) Appl. No.: 11/413,199

(22) Filed: Apr. 28, 2006

(51) Int. Cl. H04B 10/00

(52) U.S. Cl. 398/106

(57) ABSTRACT

An optical signal remote controller with narrowed acting angle having an optical signal emitter and a light guiding element used to narrow the acting angle of the optical signal emitted by the optical signal emitter is provided. The remote controller further includes a modulating apparatus, which move the light guiding element between a wide angle position and a narrow angle position to selectively narrow the acting angle. In the embodiments, a laser position indicator is also provided to indicate the targeting direction of acting angle.

### BACKGROUND OF THE INVENTION

1. Field of Invention

The present invention relates to a device for narrowing the acting angle of a remote control, and more particularly to a device for modulating the acting angle of an optical signal remote control.

2. Related Art

The function of a common remote controller is emitting the specifically encoded optical signal or radio frequency electrical signal to a receiving end, which is decoded by the receiving end to generate the corresponding operation. The infrared remote controller provides the optical signal by the infrared emitter, and it is the most economical and common manner. The infrared emitter is mainly the infrared Light Emitting Diode (LED), and commonly the view angle is approximately between 15 and 80 degrees. Of course, suitable forms may be selected to meet design-specific requirements. However, when the acting angle needs to be narrowed, or the same remote controller needs the wide angle selection and the narrow angle selection simultaneously, the design of the current remote controller or the infrared emitter may not achieve the request. A typical example is that when a series of devices with the same property (e.g. a plurality of electric jalousies) are disposed closely, of course it is easy to control quite a few devices simultaneously by using a remote control. However, on the contrary, it becomes difficult to control one of the devices separately. Although one possible manner is changing individual encoding corresponding manner, that is the remote controller must preselect and preset the individual devices, so as to facilitate distinguishing the encoding sections and the decoding sections of the remote controller and different devices, however, it makes construction, setting, and operation between the remote controller and each device difficult and inconvenient.

The possibility of using the infrared remote controller to correspondingly control individual devices may start from narrowing the acting angle of the optical signal. Desirably, the user only needs to point the remote controller to the specific device to actuate it, without affecting adjacent devices of the same series. On the other hand, an easy switching manner is needed to make the wide angle modulation and the narrow angle modulation being achieved on the same remote control. In this manner, the user may easily switch and remote controller the operation of a single or a plurality of devices of the same series at a time. It is preferred to have laser and other marks for guidance during narrow angle operating, facilitating the user's selecting an object to be controlled. However, this kind of device did not exist in market.

### SUMMARY OF THE INVENTION

In view of the above problems, an object of the present invention is to provide a modulating function of narrowing the acting angle of an optical signal remote control, such that the optical signal remote controller works at least between a wide angle range and a narrow angle range, which can not only control the action of a plurality of receiving devices with the wide angle range, but also control a single receiving device with the narrow angle range. The light guiding element is movable, so as to conveniently switch between the operating states of the wide angle and the narrow angle and be taken in. Also, a laser position indicator may be included when using the present optical signal remote control, so as to indicate the direction of the acting angle.

In order to achieve the object, the present invention provides an optical signal remote controller with narrowed acting angle, which includes an optical signal emitter emitting a optical signal and a light guiding element disposed adjacent to the optical signal emitter for narrowing the acting angle of the optical signal.

The remote controller of the present invention further comprises a modulating means, which can selectively modulate the light guiding element, such that the remote controller works at least between a wide angle range and a narrow angle range.

An exemplary embodiment of the remote controller of the present invention is selectively disposing the light guiding element between a wide angle position (the position in front of the optical axis of the optical signal emitter) and a narrow angle position (the position away from the optical axis position of the optical signal emitter), so as to modulate the acting angle of the optical signal.

Another embodiment is that the light guiding element is a sleeve having a through hole, and the sleeve can move to make the through hole relatively move on the optical axis direction of the optical signal, so as to modulate the acting angle.

An alternate embodiment is that the light guiding element may pivotally move between the wide angle position and the narrow angle position. The light guiding element is located in front of the optical signal emitter when pivoting to the narrow angle position and the light guiding element is rotated back to fit the outer body of the remote controller when pivoting to the wide angle position.

In yet another embodiment, for ease of operation, the remote controller of the present invention has a prestressed element having a force to keep the light guiding element at the narrow angle position to narrow the acting angle. When a user moves the light guiding element to the wide angle position, the remote controller can emit a wide acting angle optical signal. In addition, the remote controller further comprises a latch to latch the light guiding element at the wide angle position. Therefore, the light guiding element can be kept at the wide angle position until the latch is released. Simultaneously, when a user releases the latch, the light guiding will automatically back to the narrow angle position by the force of the prestressed element.

In still another embodiment of the remote controller, it comprises a first optical signal emitter arranged adjacent to a light guiding element, a second optical signal emitter and a electrical switch. One of the first and second optical signal emitters is selectively switched by the electrical switch, so as to emit a wide acting angle or a narrow acting angle optical signal.

Further, the embodiment of the remote controller of the present invention further comprises a laser position indicator. Laser position indicator emits a visible light beam to indicate the object to be remote controlled by the optical signal.

In the present invention, the light guiding element is a sleeve having a through hole. It is preferred that the size of an end of the through hole near the optical signal emitter is relatively less than the size of the other end, and the sleeve has a smooth inner wall. Also, the sleeve of the through hole may take the form of a suitable step shape, so as to obtain the best angle narrowing function.

Moreover, the light guiding element may also be a light guiding cylinder. It is preferred that the size of an end of the light guiding element near the optical signal emitter is relatively less than the size of the other end, the light guiding cylinder has a smooth outer wall, and one end of the light cylinder away from the optical signal represents a slight convex.

Furthermore, the light guiding element may be a lens to converge the divergence angle of the optical signal. The lens can also be moved by a mechanical or electrical mechanism to narrow the acting angle step by step.

The advantage of the present invention is that a remote controller is used to simultaneously control a series of devices with the same property disposed closely. Also, the actuating of any one of the devices may be controlled freely and separately.

The feature and function of the present invention are given below with the drawings and the preferred embodiment.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1A is a schematic appearance view of a narrow angle acting state according to the first embodiment of the present invention;

FIG. 1B is a schematic appearance view of a wide angle or received state according to the first embodiment of the present invention;

FIG. 1C is a front view of the modulating configuration of the narrow angle and the wide angle of the first embodiment of the present invention;

FIG. 1D is a front view of the wide angle acting position of the first embodiment of the present invention;

FIG. 1E is a front view of the narrow angle acting position of the first embodiment of the present invention;

FIG. 1F is a constitution diagram of partial means of the modulating means (the part F in FIG. 1A) of the first embodiment of the present invention;

FIG. 2A is a front view of the modulating configuration of the narrow angle and the wide angle of the second embodiment of the present invention;

FIG. 2B is a front view of the wide angle acting position of the second embodiment of the present invention;

FIG. 2C is a front view of the narrow angle acting position of the second embodiment of the present invention;

FIG. 3A is a front view of the wide angle acting position of the third embodiment of the present invention;

FIG. 3B is a front view of the narrow angle acting position of the third embodiment of the present invention;

FIG. 4A is a front view of the wide angle acting position of the fourth embodiment of the present invention;

FIG. 4B is a front view of the narrow angle acting position of the fourth embodiment of the present invention;

FIG. 5A is a sectional view of part of the configuration containing the laser position indicator of the fifth embodiment of the present invention;

FIG. 5B is a schematic view of the laser marking and the narrow angle acting according to the fifth embodiment of the present invention;

FIG. 6 is a schematic view of the laser marking and the narrow angle acting according to the sixth embodiment of the present invention;

FIG. 7 is a schematic view of the laser marking and the narrow angle acting of the seventh embodiment of the present invention;

FIG. 8A is a schematic functional view of the sleeve-shaped light guiding element of the present invention;

FIG. 8B is a schematic functional view of the gradual change of the size of the sleeve-shaped light guiding element of the present invention;

FIG. 9A is a schematic functional view of the light guiding cylinder light guiding element of the present invention;

FIG. 9B is a schematic functional view of the gradual change of the size of the light guiding cylinder light guiding element of the present invention;

FIG. 9C is a schematic functional view of the light guiding cylinder light guiding element with one end presenting a slight convex according to the present invention;

FIG. 10A is a schematic view of the section and end of another embodiment of the sleeve light guiding element of the present invention; and

FIG. 10B is a schematic view of the configuration of the embodiment of FIG. 10A.

### DETAILED DESCRIPTION OF THE INVENTION

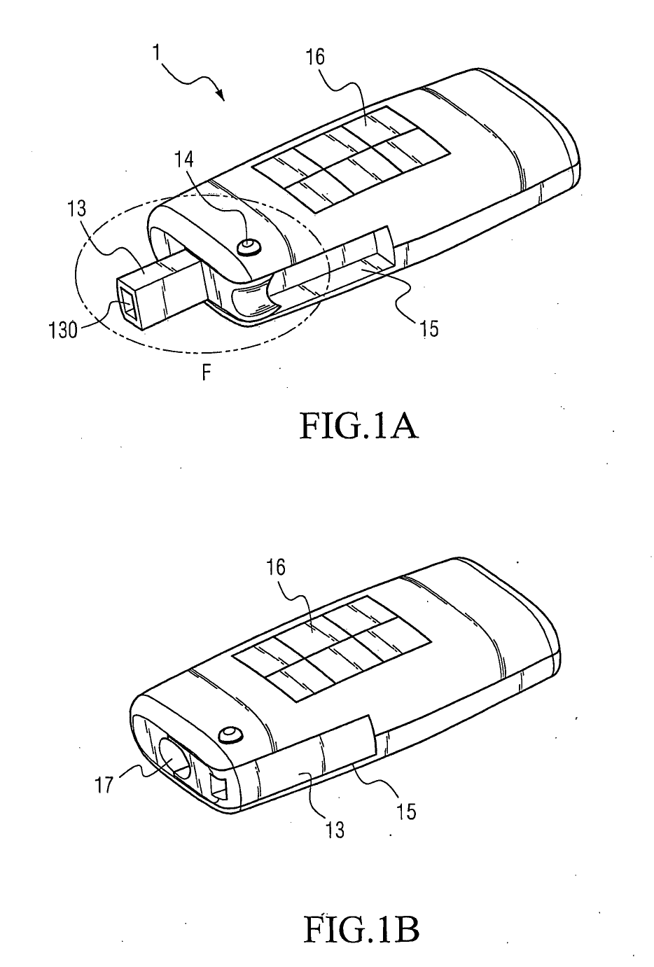

As shown in FIG. 1A and FIG. 1B, they are appearance views of the state of the narrow angle and the wide angle (and receiving) of the remote controller with narrowed acting angle according to the first embodiment of the present invention. A remote controller 1 has a light guiding element 13 pivotally bonded to a body via a pivot 14. The light guiding element 13 has a light guiding path 130. In FIG. 1A, the light guiding element 13 is rolled out of the body at a narrow angle position. When the user presses any operating button 16, the corresponding optical signal (not shown) is narrowed and guided through the light guiding path 130. In FIG. 1B, the light guiding element 13 is rolled back into an accommodation part 15 on a side of the body at a wide angle position. When the user presses any operating button 16, the corresponding optical signal (not shown) is emitted with a wide angle through an opening 17.

FIG. 1C is a front view of the modulating configuration of the aforementioned narrow angle and wide angle. The light guiding element 13 is rolled forward and backward 180 degrees about the pivot 14, so as to roll out of and back into the accommodation part 15 of the body. As shown in FIG. 1D, after the light guiding element 13 is rolled back into the accommodation part 15 of the body and when the operating button 16 is pressed, an optical signal emitter 5 disposed inside the body can naturally emit an optical signal for remote control thereof with an original wide angle w through the opening 17. As shown in FIG. 1E, when the light guiding element 13 is rolled out of the accommodation part 15 of the body, one end of the light guiding element 13 is connected adjacent to the front of the optical axis of the optical signal emitter 5 inside the body. When the operating button 16 is pressed, the optical signal originally emitted with a wide angle w is narrowed and guided into an optical signal emitted with a narrow angle n by the elongate light guiding path 130. The configuration of the light guiding element 13 is described below.

The switch between the narrow angle and the wide angle in the above drawings can be achieved by the pull of the user, or by an automatic ejection mechanism (the marked part F of FIG. 1A) shown in FIG. 1F. The mechanism mainly contains a pivot 14 inserted at one end of the hole 131 formed in the light guiding element 13, and supported upward by a prestressed element 19. The prestressed element 19 can be a torsion spring means with straight sections 191, 192 respectively at the upper end and the lower end thereof, wherein the straight sections 191, 192 can be embedded into a claw (not shown) under the pivot 14 and a claw 122 in a recess 121 of the lower cover 12 of the body. Two protrusions 132 formed on the inner wall of the hole 131 in the light guiding element 13 can well slide into two sliding slots 143 formed on the periphery of the pivot 14. The pivot 14, light guiding element 13, and prestressed element 19 after being bonded are clipped between the upper cover 11 and the lower cover 12 of the body, and are combined by bonds such as screws (not shown). The cylindrical surface of the pivot 14 forms two planes 142 that can be well embedded into notches (not shown) of the same shape around the hole 110 in the upper cover. Thereby, the upper cylinder 141 of the pivot 14 appears out of the hole 110. When the user presses the pivot 14 downward, and the sliding slot 143 moves downward slightly along the protrusions 132 against the supporting force of the torsion spring, i.e., the prestressed element 19, the two planes 142 detach from the seizing of the notches in the upper cover 11, the prestressed element 19, i.e., the torsion spring prestressed by torsion prestress drives the pivot 14 to automatically roll out together with the light guiding element 13. Then, after rotating 180 degrees, the two planes 142 are again embedded into the notches in the upper cover 11 and are seized. When the light guiding element 13 is to be rolled back, the user re-presses the pivot 14 downward to release the seizing and pulls the light guiding element 13 back into the accommodation part 15 of the body, such that the pivot 14 springs upward and is seized again.

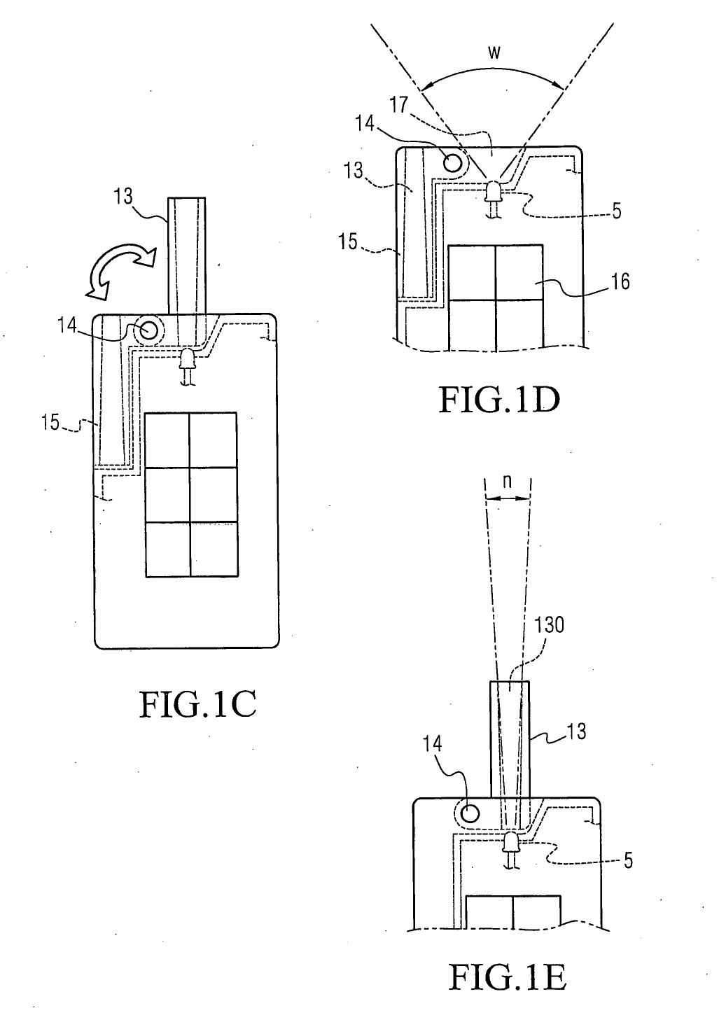

FIGS. 2A to 2C are a front view of the configuration and a schematic view of the remote controller with narrowed acting angle according to the second embodiment of the present invention. As shown in FIG. 2A, the light guiding element 13 can be rolled forward and backward 90 degrees out of or back into the accommodation part 15 of the body via the pivot 14. As shown in FIG. 2B, after the light guiding element 13 is rolled back into the accommodation part 15 of the body at a wide angle position and when the operating button 16 is pressed, the optical signal emitter 5 disposed in the body can naturally emit the optical signal with the original wide angle w through an opening 17. As shown in FIG. 2C, when the light guiding element 13 is rolled out of the accommodation part 15 of the body at a narrow angle position, one end of the light guiding element 13 is connected adjacent to the front of the optical axis of the optical signal emitter 5 inside the body. When the operating button 16 is pressed, the optical signal formerly emitted with the original wide angle w is narrowed and guided into an optical signal emitted with a narrow angle n via the light guiding element 13. The inner configuration of the pivot 14 may be constituted in a similar way as that of FIG. 1F, so as to achieve the automatic ejection operation of the light guiding element 13.

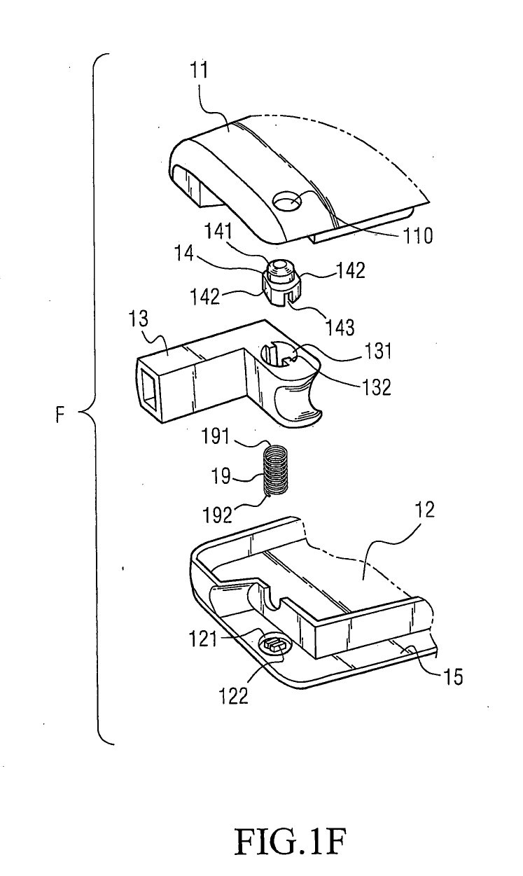

FIG. 3A and FIG. 3B are a partial front sectional view and a schematic functional view of the remote controller with narrowed acting angle according to the third embodiment of the present invention. As shown in FIG. 3A, the light guiding element 13 is retractably disposed at a guiding hole 18 of the body at a wide angle position. A notch and an extending part 162 are formed on a printed circuit board (PCB) 161 in the body, wherein the light guiding element 13 is sleeved on the extending part 162 without touching it. A flange 134 of the inner end of the light guiding element 13 is supported by a compression spring 135 to provide an outward pushing prestress. A latch 6 is pushed by the compression spring 65 to latch the light guiding element 13 by a shoulder 133 when the light guiding element 13 is pressed into the body by the user. An optical signal emitter 5 is disposed at the top of the extending part 162. As shown in FIG. 3A, when the light guiding element 13 is rolled back into the body, the optical signal emitter 5 is just outside the light guiding element 13. When the operating button 16 is pressed, the optical signal emitter 5 can naturally emit the optical signal with the original wide angle w. As shown in FIG. 3B, when the user releases the latch 6, the light guiding element 13 extends out of the body till the flange 134 at the inner end reaches the lower end of the guiding hole 18 via the force of the compression spring 135. The light guiding element is at a narrow angle position. At this moment, the optical signal emitter 5 is relatively located at the inner end of the light guiding element 13, so when the operating button 16 is pressed, the optical signal emitted with the original wide angle w is narrowed and guided into an optical signal emitted with a narrow angle n via the light guiding element 13. In addition, the light guiding element 13 can be disposed between the wide angle position and the narrow angle position to adjust the acting angle.

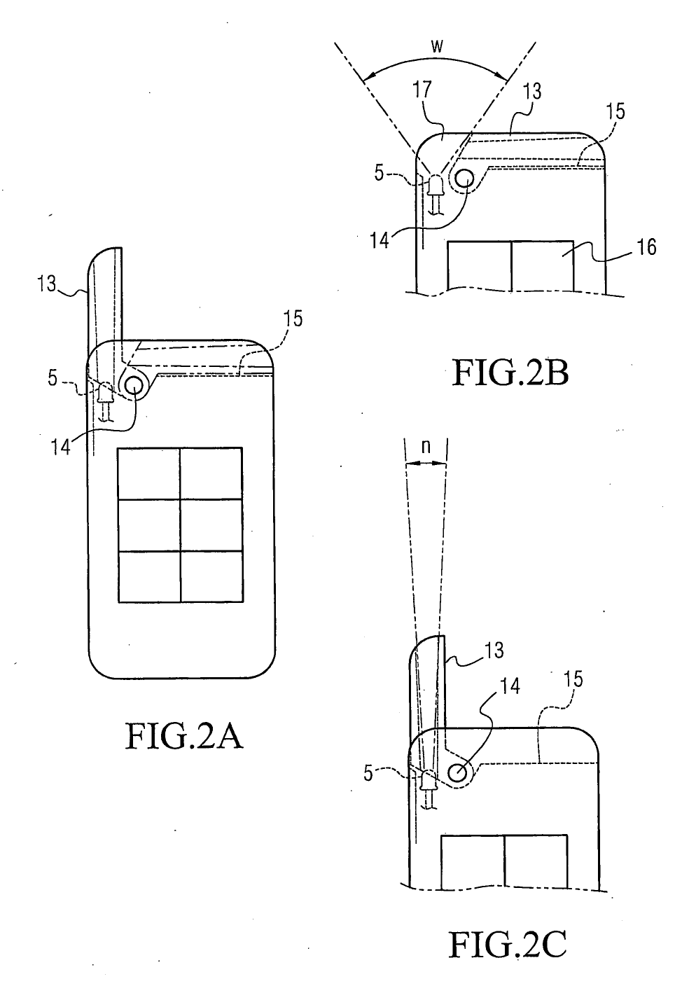

FIGS. 4A and 4B are a partial front sectional view and a schematic functional view of the remote controller with narrowed acting angle according to the fourth embodiment of the present invention. As shown in FIG. 4A, the remote controller of the present invention has a first optical signal emitter 51 of wide angle disposed in the body and near an opening, and a second optical signal emitter 52 disposed next to an inner end 137 of a light guiding element 13. The light guiding element 13 is fixed in the body and the outer end 138 thereof is just located at an opening of the body. An electric switch 56 selectively connects a remote controller driving electric signal S initiated by the operating button 16 to a line PI of the first optical signal emitter 51, such that the first optical signal emitter 51 emits a first optical signal with a wide angle w. As shown in FIG. 4B, the select switch 56 selectively connects the remote controller driving electric signal S to a line P2 of the second optical signal emitter 52, such that the second optical signal emitter 52 emits a second optical signal with a narrow angle n via the light guiding element 13.

When the remote controller of the present invention emits with a narrow angle, in order to facilitate the user aiming at objects to be controlled to operate, it is necessary to provide a remote target object indicating mechanism. The present invention further provides a laser device for the user to select the object by indicating with a laser beam before the emitting of the optical signal with a narrow angle. Here, the first, the third, and the fourth embodiments appended with a laser device are described in the following part as further embodiments.

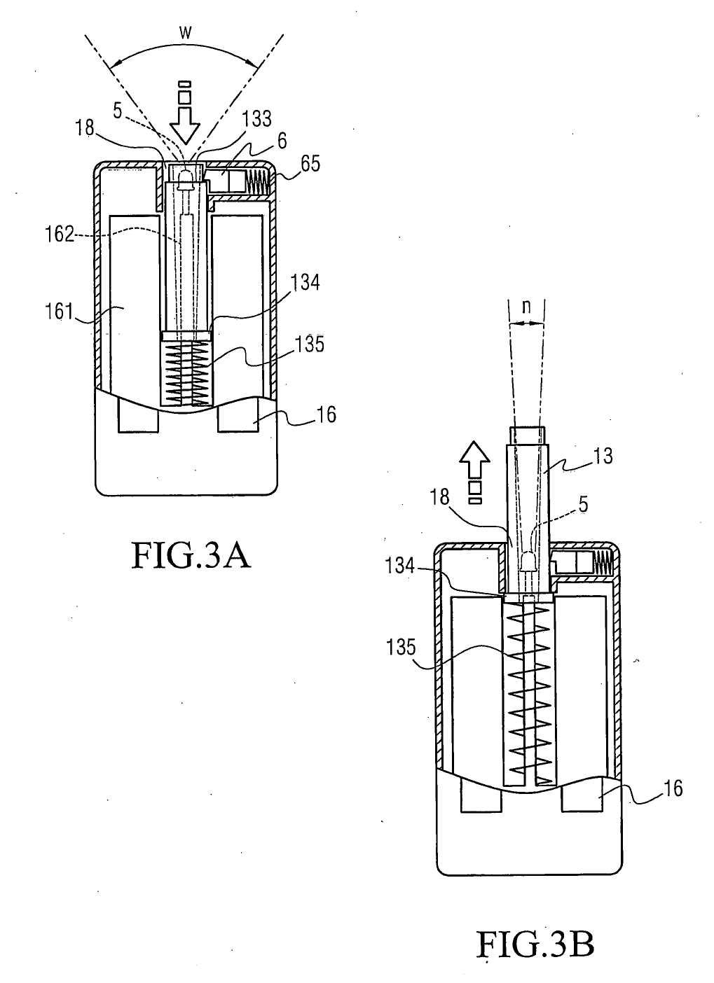

FIGS. 5A and 5B are a sectional view of the partial configuration and a schematic functional view of the fifth embodiment containing a laser position indicator of the present invention. In addition to the light guiding element 13 and the optical signal emitter 5 of the first embodiment, a linked switch 8 is properly disposed adjacent to the light guiding element 13, such that the linked switch 8 is disconnected when the light guiding element 13 is received, as shown in FIG. 5A and is electrically connected when the light guiding element 13 is rolled out via the pivot 14, as shown in FIG. 5B. A laser position indicator (for example, a laser diode) 9 is electrically connected to the linked switch 8, wherein the laser position indicator emits a visible beam L aiming at the target object when the operating button 16 is pressed, so as to facilitate the user to position the object. Then, after a preset time (for example, one second), the optical signal emitter 5 emits an optical signal of a narrow angle n to remotely control the object via the light guiding element 13.

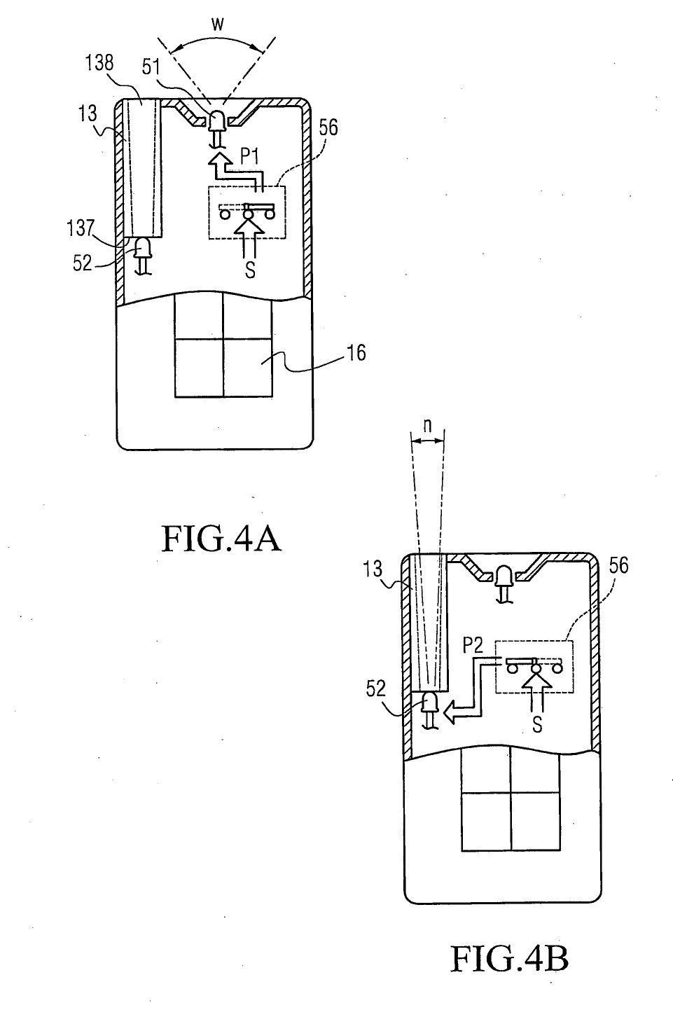

FIG. 6 is a sectional view of the partial configuration and schematic functional view of the sixth embodiment containing a laser position indicator of the present invention. In addition to the retractable light guiding element 13 and the optical signal emitter 5 of the third embodiment, a linked switch 81 with a movable piece is disposed at the flange 134 of the inner end of the light guiding element 13 after being extended out, such that the linked switch is disconnected to a fixed contact 82 due to the detachment of the flange 134 when the light guiding element 13 is received and is connected to the fixed contact 82 under the push of the flange 134 when the light guiding element 13 is received, as shown in FIG. 6. A laser position indicator (for example, a laser diode) 9 is electrically connected to the linked switch 81, fixed contact 82, and another switch 86. When the operating button 16 is initially pressed (lightly pressing, and the contact of the button itself is not turned on), the laser position indicator 9 firstly emits the laser beam L pointing to the aimed object, to help the user to position. Then, the operating button 16 is continuously pressed to be turned on, and the optical signal emitter 5 emits an optical signal of a narrow angle n to remotely control the object via the light guiding element 13. The switch 86 is a switch for the first stage of the button under a button group support surface 160 where the operating button 16 is located, i.e. when the light guiding element 13 is rolled out and any operating button 16 is lightly pressed, the switch 86 is first turned on to make the laser position indicator 9 irradiate to help the user to adjust the object. When the light guiding element 13 is received, the laser position indicator 9 fails by being electrically disconnected due to the linked switch 81 and the fixed contact 82.

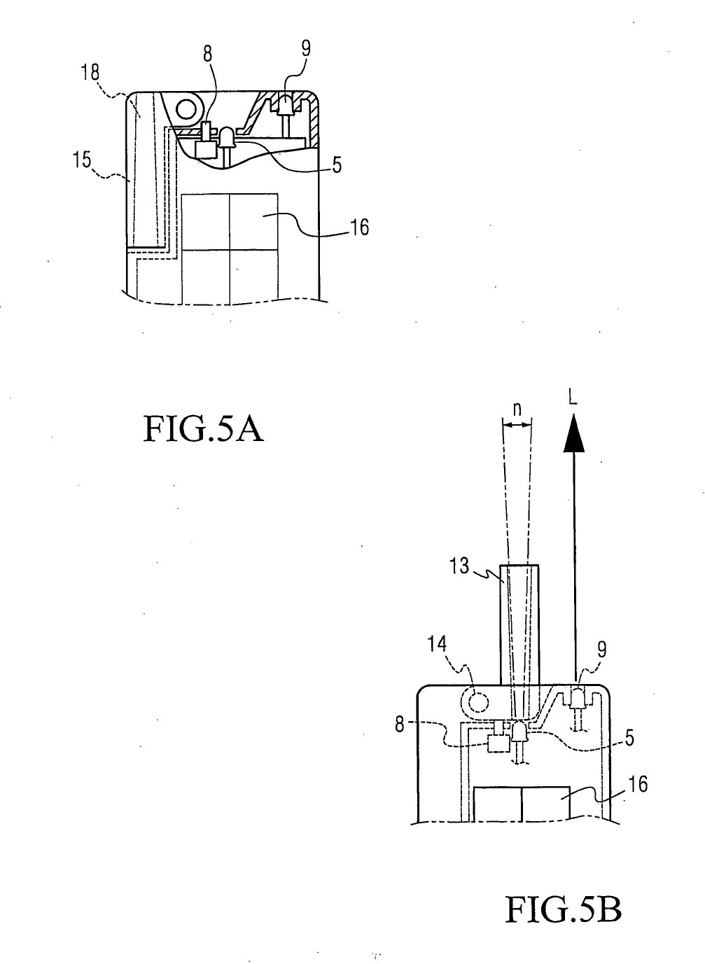

FIG. 7 is a sectional view of the partial configuration and schematic functional view of the seventh embodiment containing a laser position indicator of the present invention. In addition to the fixed light guiding element 13, two optical signal emitters 51, 52, and select switch 56 of the fourth embodiment, the select switch 56 links a state switch 561, such that when the remote controller is selected with a narrow acting angle, a laser position indicator (for example, a laser diode) 9 is electrically connected to the state switch 561 and another switch 86. When the operating button 16 is initially pressed (lightly pressing, and the contact of the press key itself is not turned on), the laser position indicator first emits the laser beam L pointing to the aimed object, to help the user to position. Then, the operating button 16 is continuously pressed to be turned on, and the optical signal emitter 5 emits an optical signal with a narrow angle n to remotely control the object via the light guiding element 13. The switch 86 is a switch for the first stage of the button under the button group support surface 160 where the operating button 16 is located, i.e. when the remote controller is selected with a narrow acting angle and any operating button 16 is lightly pressed, the switch 86 is turned on first to make the laser position indicator 9 irradiate to help the user to adjust the object. When the light guiding element 13 is received, the laser position indicator 9 fails by being electrically disconnected due to the state switch 561.

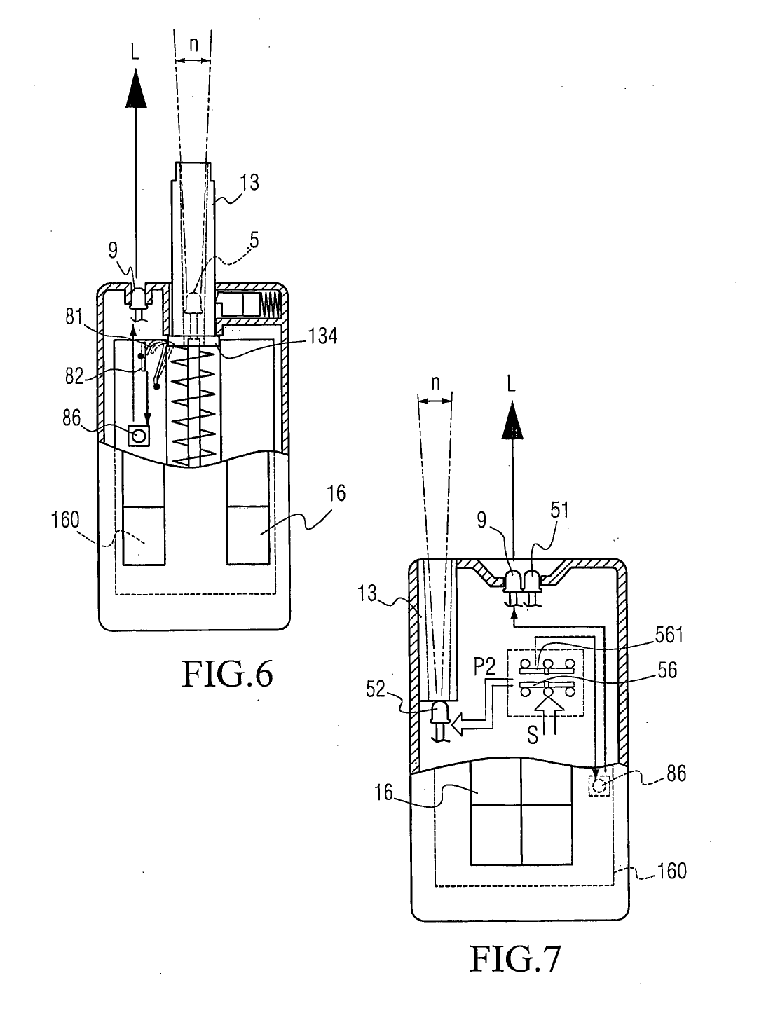

As shown in FIGS. 8A and 8B, in the present invention, the light guiding element 13 is substantially an elongate hollow sleeve with a section slightly larger than that of the optical signal emitter 5, e.g. the straight circular sleeve with a diameter of size d as shown in FIG. 8A, and of course the section may be square or other shapes. Or, as the cone-shaped sleeve shown in FIG. 8B, the size d1 of an inner end 137 of the sleeve close to the optical signal emitter 5 is relatively smaller than the size d2 of the other outer end 138. The sleeve has a smooth inner wall, such that the included angle between the optical signal with a relatively wide angle emitted by the optical signal emitter 5 and the optical axis a is reduced during the reflections of the optical signal in the sleeve and thus the optical signal tends to be emitted straightly along the optical axis a. Of course, in order to enhance the narrowing of the angle, the length of the light guiding element 13 can be increased or an optical signal emitter 5 with a smaller view angle is selected.

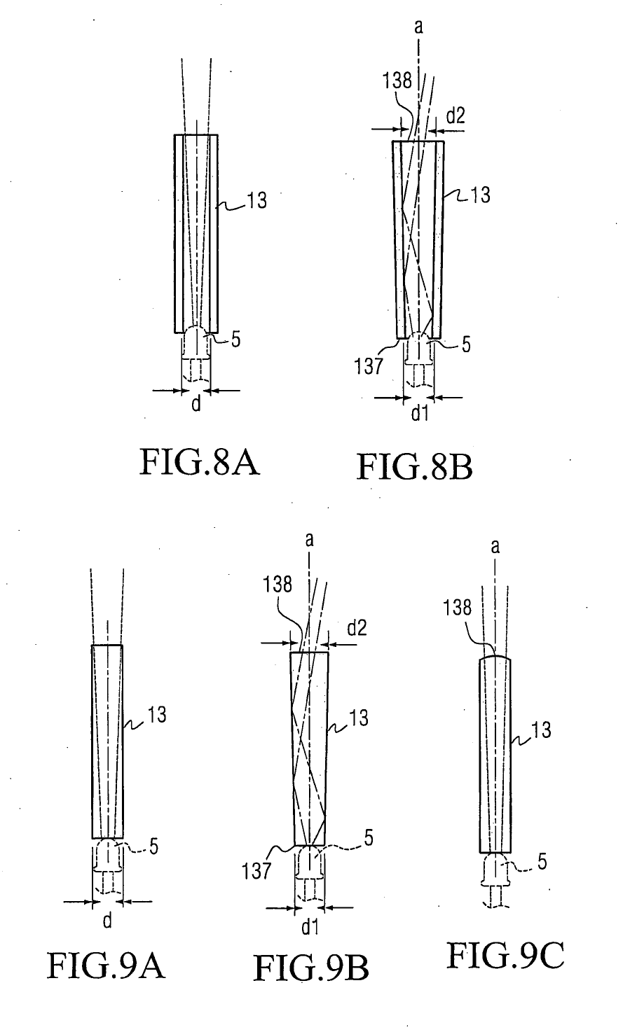

Moreover, as shown in FIGS. 9A to 9C, in the present invention, the light guiding element 13 may also be substantially an elongate light guiding cylinder (ex. light guide or optical fiber) with a section slightly larger than that of the optical signal emitter 5, for example, a cylinder acrylic or other transparent light guiding means with a diameter of size d as shown in FIG. 9A, and of course the section may also be square or other shapes. Or, as the cone-shaped cylinder shown in FIG. 9B, the size dl of an inner end 137 of the cylinder close to the optical signal emitter 5 is relatively smaller than the size d2 of the other outer end 138. The light guiding cylinder has a smooth external wall, such that the optical signal with a relatively wide angle emitted by the optical signal emitter 5 can generate total reflection on the external wall of the cylinder, and the included angle between the optical signal and the optical axis a is reduced during the reflections and thus the optical signal tends to be emitted straightly along the optical axis a. Of course, in order to enhance the narrowing of the angle, the length of the light guiding element 13 can be increased or an optical signal emitter 5 with a smaller view angle is selected. Moreover, as shown in FIG. 9C, an outer end 138 of the light guiding cylinder away from the optical signal emitter 5 optimally represents a slight convex, such that the optical signal that may be emitted slightly obliquely tends to be emitted parallel to the optical axis a when leaving the light guiding cylinder due to refraction. Besides, the light guiding element may be a lens to converge the divergence angle of the optical signal. The lens can also be moved by a mechanical or electrical mechanism to narrow the acting angle step by step.

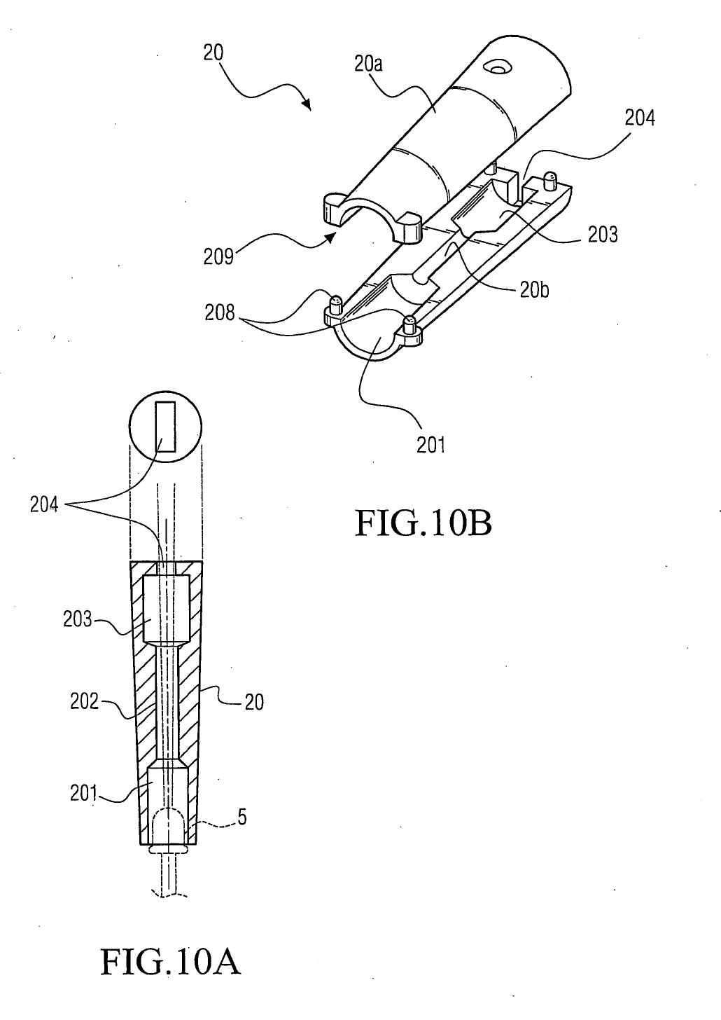

FIG. 10A is a schematic view of the section and end of another embodiment of the sleeve-shaped light guiding element of the present invention. A step-shaped light guiding element 20 has a step-shaped through hole, which includes a light input end 201 to accommodate the optical signal emitter 5; a narrowing section 202 with a relatively small section, so as to narrow the angle of light rays passing through; a scattering section 203 with a relatively enlarged section, in which the light rays with relatively big angles entering the area are reflected and scattered automatically; and a light output end 204 with a relatively narrowed section, particularly an elongate slot as shown in the drawing to make the light emitted in an elongate shape, e.g. being narrow on the left and right angles and wide on the upper and lower angles, for the ease of remote control. FIG. 10B is a schematic view of the configuration of the present embodiment. The step-shaped light guiding element 20 may be formed by jointing the upper and lower means 20a, 20b through a plurality of positioning poles 208 and holes 209, so as to form the required internal light input end 201, narrowing section 202, scattering section 203, light output end 204, and so on.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An optical signal remote controller with narrowed acting angle, comprising:
a first optical signal emitter, for emitting a first optical signal for remote control; and
a light guiding element, disposed adjacent to the first optical signal emitter for narrowing the acting angle of the first optical signal.

2. The remote controller as claimed in claim 1, wherein the light guiding element is fixed adjacent to the first optical signal emitter.

3. The remote controller as claimed in claim 2, further comprising a second optical signal emitter emitting a second optical signal for remote control and an electrical switch alternatively make the first or second optical signal emitter emit the first or second optical signal.

4. The remote controller as claimed in claim 1, wherein the light guiding element selectively moving between at least a wide angle position and at least a narrow angle position.

5. The remote controller as claimed in claim 4, further comprising a pivot pivoting the light guiding element between the wide angle position and the narrow angle position.

6. The remote controller as claimed in claim 4, further comprising a guiding hole guiding the light guiding element between the wide angle position and the narrow angle position.

7. The remote controller as claimed in claim 4, further comprising a prestressed element having a force to keep the light guiding element at the narrow angle position.

8. The remote controller as claimed in claim 7, further comprising a latch to latch the light guiding element when the light guiding element is at the wide angle position and to release the light guiding element when a user releases the latch.

9. The remote controller as claimed in claim 7, wherein the prestressed element is a spring.

10. The remote controller as claimed in claim 1, the light guiding element is a sleeve having a through hole for narrowing the acting angle of the first optical signal.

11. The remote controller as claimed in claim 10, wherein the size of an end of the through hole near the first optical signal emitter is relatively smaller than the size of the other end.

12. The remote controller as claimed in claim 10, wherein the through hole has at least a narrowing section to narrow the acting angle of the first optical signal and a scattering section to scatter the first optical signal.

13. The remote controller as claimed in claim 10, wherein the sleeve has a smooth inner wall.

14. The remote controller as claimed in claim 1, wherein the light guiding element is a light guiding cylinder.

15. The remote controller as claimed in claim 14, wherein the size of an end of the light guiding cylinder near the first optical signal emitter is relatively less than the size of the other end.

16. The remote controller as claimed in claim 14, wherein the light guiding cylinder has a smooth outer wall.

17. The remote controller as claimed in claim 14, wherein an end of the light guiding cylinder away from the optical signal represents a convex.

18. The remote controller as claimed in claim 1, wherein the light guiding element is a focusing lens to converge the divergence angle of the first optical signal.

19. The remote controller as claimed in claim 14, the light guiding cylinder is a light guide.

20. The remote controller as claimed in claim 1, further comprising a laser position indicator, emitting a visible beam directing the direction of the acting angle.
